(19) United States
(12) Patent Application Publication
(10) Pub. No.: US 2008/0068395 A1
(43) Pub. Date: Mar. 20, 2008

(54) Display device

(75) Inventors: Ikuko Mori, Chiba (JP); Kikuo Ono, Mobara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 11/898,280

(22) Filed: Sep. 11, 2007

(30) Foreign Application Priority Data
Sep. 19, 2006 (JP) 2006-252137

(51) Int. Cl. G09G 5/02

(52) U.S. Cl. 345/592

(57) ABSTRACT

The present invention reduces moving image blurring in a hold-response-type display device. 1 frame is divided into 3 fields. Assuming the gradation-brightness characteristic of a first field as 1g, the gradation-brightness characteristic of a second field as 2g, and the gradation-brightness characteristic of a third field as 3g, the third field is set at an initial stage or at a final stage of the frame. Due to such setting, the moving image blurring can be effectively reduced up to the relatively high brightness.

The present application claims priority from Japanese application JP2006-252137 filed on Sep. 19, 2006, the content of which is hereby incorporated by reference into this application.

### BACKGROUND OF THE INVENTION

1. Field of the Invention

The present invention relates to a hold-response-type display device such as a liquid crystal display device or an organic EL display, and more particularly to a display device suitable for a display of moving images.

2. Description of the Related Art

In classifying a display device particularly from a viewpoint of a moving image display, the display device is roughly classified into an impulse-response-type display and a hold-response-type display. The impulse-response-type display is a display of a type in which a brightness response is lowered immediately after scanning as in the case of light emission characteristic of a cathode ray tube, while the hold-response-type display device is of a type in which the brightness based on display data is continuously held until next scanning as in the case of a liquid crystal display.

As a characteristic of the hold-response-type display, the display can obtain favorable display quality with no flickers when a still image is displayed. However, in displaying a moving image, the hold-response-type display has a drawback that so-called moving image blurring in which a periphery of a moving object is blurred is generated and hence, display quality is lowered. The occurrence of the moving image blurring is attributed to so-called retina image retention in which when a viewer moves his/her sight line along with the movement of the displayed object, the viewer interpolates display images before and after the movement with respect to the displayed image whose brightness is held. Accordingly, even when a response speed of the display is enhanced as fast as possible, it is impossible to completely eliminate the moving image blurring. To overcome this drawback, it is effective to adopt a method which approximates a visual effect to a viewer to a corresponding visual effect of the impulse-response-type display by temporarily canceling the retina image retention with updating of a display image at shorter frequency or with the insertion of a black screen or the like.

On the other hand, a typical example of the display which is required to perform a moving image display is a television receiver set, wherein scanning frequency characteristic of the television receiver set is standardized to 60 Hz in scanning with respect to NTSC signals and to 50 Hz in scanning with respect to PAL signals, for example. Accordingly, when frame frequency of a display image which is formed based on these scanning frequencies is set to 60 Hz or 50 Hz, the frequency is not so high that moving image blurring occurs.

As means for reducing the moving image blurring, there has been known a technique which updates the image at a shorter cycle as described above. In the technique, scanning frequency is elevated and, at the same time, display data of an interpolation frame is generated based on display data between frames thus enhancing an updating speed of images (an interpolation frame generation method) (see patent document 1: JP-A-2005-6275 corresponding US patent application publication No. US2004/0101058A1). As another technique which inserts the above-mentioned black screen (black frame), there has been proposed a technique which inserts black display data between display data (hereinafter abbreviated as black display data insertion method) or a technique which repeats turning on and off of a backlight (hereinafter abbreviated as blink backlight method) (see patent document 2: JP-A-2003-280599 corresponding U.S. Pat. No. 7,027,018).

Although the moving image blurring can be reduced by applying the above-mentioned techniques to the hold-response-type display device, there has been known that the following drawbacks arise due to the application of such techniques.

In the above-mentioned interpolation frame generation method, the display data of the interpolation frame which does not originally exist is generated. Accordingly, to generate more accurate display data, a circuit scale is increased. On the other hand, when the circuit scale is suppressed, the interpolation errors occur.

On the other hand, in the technique which inserts the black frame, in principle, there arise no interpolation errors. Further, also in view of the circuit scale, the black frame insertion method is advantageous compared to the interpolation frame generation method. However, with respect to both of the black display data insertion method and a blink backlight method, the display brightness is lowered in all gradations by an amount corresponding to the black frame.

As a method which improves the technique for inserting the black frame, there has been known a technique which performs black insertion while suppressing lowering of brightness by forming 1 frame using 2 fields. That is, this is a method which forms one frame screen by preparing two field memories and by writing image data of 2 fields to a liquid crystal display with frequency twice as large as frequency of an input signal. FIG. 14 shows the relationship between gradations and brightness in 2 fields.

FIG. 14 displays grayscales of 256 gradations. The first field is allocated to a case in which the brightness is equal to or less than a 171th gradation. When the brightness is equal to or less than the 171th gradation, an output from the second field may be set to zero. That is, when the gradation is equal to or less than the 171th gradation, it is possible to perform the black insertion without lowering the brightness. When the gradation exceeds the 171th gradation, for example, when the gradation shown in FIG. 14 is a 200th gradation, the brightness data is also outputted from the second field and hence, a complete black insertion effect cannot be obtained. However, the brightness in the second field is smaller than the brightness in the first field and hence, some effect against the moving image blurring is acquired.

### SUMMARY OF THE INVENTION

It is an object of the present invention to provide means which can reduce moving image blurring by acquiring a sufficient black insertion effect also in a region of relatively high brightness by dividing 1 frame into 3 or more fields and, at the same time, by determining order of characteristics of respective fields. Specific means are as follows.

(1) In a display device of a hold response type which holds a display of gradations for a fixed period, 1 frame is divided into 3 fields, a first field displays an intermediate gradation between a 0th gradation and a gradation T1, a second field displays an intermediate gradation between the gradation T1 and a gradation T2, a third field displays an intermediate gradation between the gradation T2 and a maximum gradation, the gradation T1 and the gradation T2 are set to a relationship of gradation T1<gradation T2, and the third field is set at either one of an initial stage or a final stage of a frame.

(2) In a display device of a hold response type which holds a display of gradations for a fixed period, 1 frame is divided into 3 fields, a first field displays an intermediate gradation between a 0th gradation and a gradation T1, a second field displays an intermediate gradation between the gradation T1 and a maximum gradation, the third field always displays a black level, and the third field is set at either one of an initial stage and a final stage of a frame.

(3) In a display device of a hold response type which holds a display of gradations for a fixed period, 1 frame is divided into 4 or more fields, 4 or more fields include a first field which displays an intermediate gradation between a 0th gradation and a gradation T1, the second field which displays an intermediate gradation between the gradation T1 and a gradation T2, the fourth field which displays an intermediate gradation between the gradation T4 and a maximum gradation, and the third field which displays an intermediate gradation between the gradation T3 and the gradation T4, the gradation T1, the gradation T2, the gradation T3 and the gradation T4 are set to a relationship of gradation T1<gradation T2<gradation T3<gradation T4, and the fourth field is set at either one of an initial stage and a final stage of a frame.

(4) In a display device of a hold response type which holds a display of gradations for a fixed period, 1 frame is divided into 4 or more fields, 4 or more fields include a first field which displays an intermediate gradation between a 0th gradation anda gradation T1, a second field which displays an intermediate gradation between the gradation T1 and a gradation T2, a third field which displays an intermediate gradation between the gradation T3 and a maximum gradation, and a fourth field which always displays a black level, the gradation T1, the gradation T2 and the gradation T3 are set to a relationship of gradation T1<gradation T2<gradation T3, and the fourth field is set at either one of an initial stage and a final stage of a frame.

According to the above-mentioned means (1), by dividing 1 frame into 3 fields and by setting the field which exhibits the lowest brightness out of the respective fields either at an initial stage or at a final stage of the frame, it is possible to effectively cope with the moving image blurring attributed to black insertion. In addition to such an advantageous effect, it is possible to effectively cope with moving image blurring also by determining the order of other fields.

According to the above-mentioned means (2), by dividing 1 frame into 3 fields and by always performing a black display in one field, it is possible to surely perform black insertion even with the high brightness thus surely reducing moving image blurring even with the high brightness. Further, even when the black display is performed on the whole 1 field, a period for the black display is ⅓ of the frame period and hence, lowering of the brightness is limited.

According to the above-mentioned means (3), by dividing 1 frame into 4 or more fields and by setting the field which exhibits the lowest brightness out of the respective fields either at an initial stage or at a final stage of the frame, it is possible to effectively cope with moving image blurring attributed to black insertion.

According to the above-mentioned means (4), by dividing 1 frame into 4 or more fields and by always performing a black display in one field, it is possible to surely perform black insertion even with the high brightness thus surely reducing moving image blurring even with the high brightness. In dividing 1 frame into n fields, even when the black display is performed on the whole 1 field, a period for the black display is 1/n of the frame period and hence, lowering of the brightness is limited.

### BRIEF DESCRIPTION OF THE DRAWINGS

FIG. 1 is a block diagram showing the constitution of a liquid crystal display device;

FIG. 2 is gradation brightness characteristics of respective fields in an embodiment 1;

FIG. 3 is a conceptual view showing an example of the reduction of moving image blurring;

FIG. 4 is a conceptual view showing another example of reducing moving image blurring;

FIG. 5 is a conceptual view showing the reduction of moving image blurring in the embodiment 1;

FIG. 6 is an example of moving image blurring when 1 frame is divided into 2 fields;

FIG. 7 is a view showing a comparison example for the embodiment 1;

FIG. 8 is a conceptual view showing another mode of the embodiment 1;

FIG. 9 is a table which describes cases which are adopted when 1 frame is divided into 3 fields;

FIG. 10 is a graph showing gradation-brightness characteristics of an embodiment 2;

FIG. 11 is a view showing a comparison example for the embodiment 2;

FIG. 12 is a conceptual view showing the reduction of moving image blurring in the embodiment 2;

FIG. 13 is a graph showing gradation-brightness characteristics of an embodiment 4; and

FIG. 14 is a graph showing an example of gradation-brightness characteristics when 1 frame is divided into 2 fields.

### DESCRIPTION OF THE PREFERRED EMBODIMENT

The present invention is described in detail in conjunction with embodiments.

### Embodiment 1

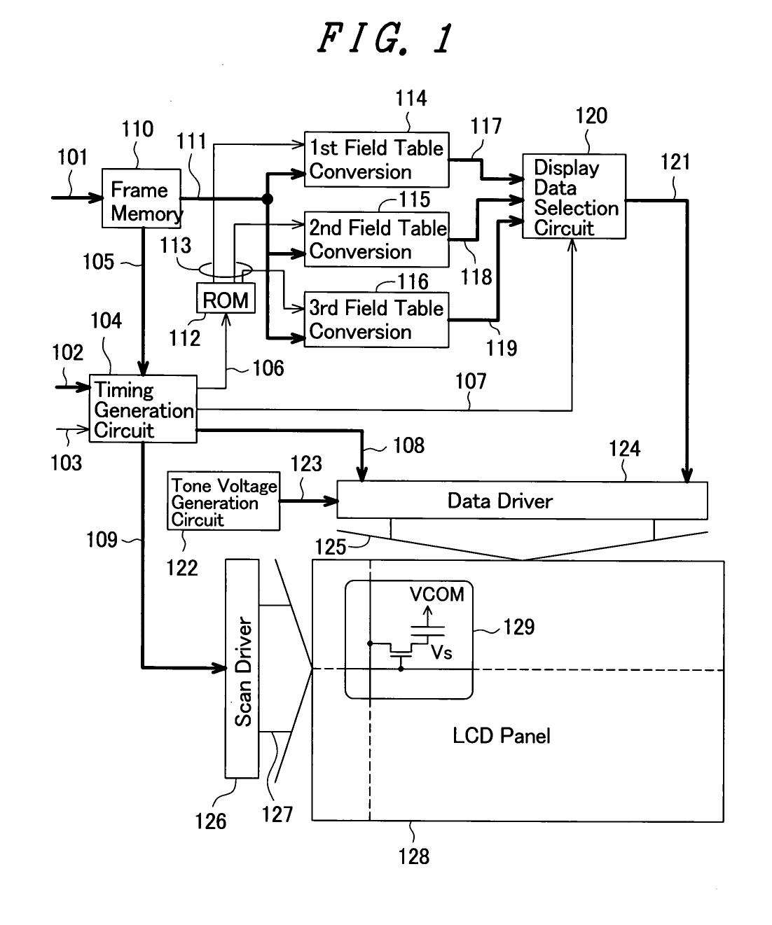

FIG. 1 is a block diagram showing the constitution of the liquid crystal display device. The display device corresponds to a display of 16,770,000 colors in total in which respective colors of R, G, B are constituted of 256 gradations. Numeral 101 indicates input display data formed of 24 bits in total in which respective colors of R, G, B are constituted of 8 bits, and numeral 102 indicates a group of input signals. The group of input signals 102 is constituted of a vertical synchronizing signal Vsync which defines 1 frame period (period in which 1 screen is displayed), a horizontal synchronizing signal Hsync which defines 1 horizontal period (period in which 1 line is displayed), a display timing signal DISP which defines an effective period of display data, and a reference clock signal DCLK which is synchronized with display data.

Numeral 103 indicates a drive selection signal. In response to the drive selection signal 103, either a conventional drive method or a drive method which reduces moving image blurring is selected. The input display data 101, a group of input signal 102, and the drive selection signal 103 are transferred from an external system (for example, a television receiver set, a PV set or a mobile phone set).

Numeral 104 indicates a timing signal generation circuit, numeral 105 indicates a group of memory control signals, numeral 106 indicates a table initializing signal, numeral 107 indicates a data selection signal, numeral 108 indicates a group of data driver control signals, and numeral 109 indicates a group of scanning driver control signals. The group of data driver control signals 108 is constituted of an output signal CL1 which defines output timing of a gradation voltage based on the display data, an AC signal M which determines polarity of a source voltage, and a clock signal PCLK which is synchronized with the display data. The group of scanning driver control signals 109 is constituted of a shift signal CL3 which defines a scanning period for 1 line, and a vertical start signal FLM which defines starting of scanning of a head line.

Numeral 110 indicates a frame memory having capacitance amounting at least 1 frame of the display data and performs reading and writing processing of display data based on the group of memory signals 105. Numeral 111 indicates memory read data which is read from the frame memory 110 in response to the group of the memory control signals 105. Numeral 112 indicates a ROM (ReadOnlyMemory) which outputs data stored in the inside thereof in response to the table initializing signal, numeral 113 indicates table data which is outputted from the ROM 112, numeral 114 indicates a first field conversion table, numeral 115 indicates a second field conversion table, and numeral 116 indicates a third field conversion table.

Values of respective tables are set based on the table data 113 at the time of supplying electricity, and the memory read data 111 read from the frame memory 110 is converted based on the values set in the respective tables. The first field conversion table 114 has a function of a data conversion circuit for the first field, the second field conversion table 115 has a function of a data conversion circuit for the second field, and the third field conversion table 116 has a function of a data conversion circuit for the third field.

Numeral 117 indicates first field display data acquired by conversion in the first field conversion table 114, numeral 118 indicates second field display data acquired by conversion in the second field conversion table 115, and numeral 119 indicates third field display data acquired by conversion in the third field conversion table 116. Numeral 120 indicates a display data selection circuit. The display data selection circuit 120 selects and outputs any one of the first field display data 117, the second field display data 118 and the third field display data 119 based on the data selection signal 107. Numeral 121 indicates field display data selected by the display data selection circuit 120.

Numeral 122 indicates a gradation voltage generation circuit, and numeral 123 indicates a gradation voltage. Numeral 124 indicates a data driver. The data driver 124 generates potentials of 512 levels in total consisting of 256 levels (2⁸ (8 powers of 2)) for positive polarity and negative polarity respectively from the gradation voltage 123 and, at the same time, selects a potential of 1 level corresponding to the field display data 121 of 8 bits for respective colors and a polarity signal M, and applies the potential to a liquid crystal display panel 128 as a data voltage.

Numeral 125 indicates a data voltage generated by the data driver 124. Numeral 126 indicates a scanning driver, and numeral 127 indicates a scanning line selection signal. The scanning driver 126 generates a scanning line selection signal 127 in response to the group of scanning driver control signals 109, and outputs the scanning line selection signal 127 to scanning lines of the liquid crystal display panel 128.

In the liquid crystal display panel 128, 1 pixel of the liquid crystal display panel 128 is schematically indicated by numeral 129. 1 pixel of the liquid crystal display panel 128 is constituted of a TFT (Thin Film Transistor) which is formed of a source electrode, a gate electrode and a drain electrode, a liquid crystal layer and a counter electrode. The TFT performs a switching operation when the scanning signal is applied to the gate electrode thereof. The data voltage is written in the source electrode which is connected with one side of the liquid crystal layer via the drain electrode when the TFT is in an open state, and the voltage written in the source electrode is held when the TFT is in a closed state. Assume the voltage of the source electrode as Vs and a counter electrode voltage as Vcom. The liquid crystal layer changes the polarization direction based on the potential difference between the source electrode voltage Vs and the counter electrode voltage Vcom and, at the same time, a transmission light quantity from a backlight arranged on a back surface of the liquid crystal display panel 128 is changed via the polarizer arranged above and below the liquid crystal layer thus performing a gradation display.

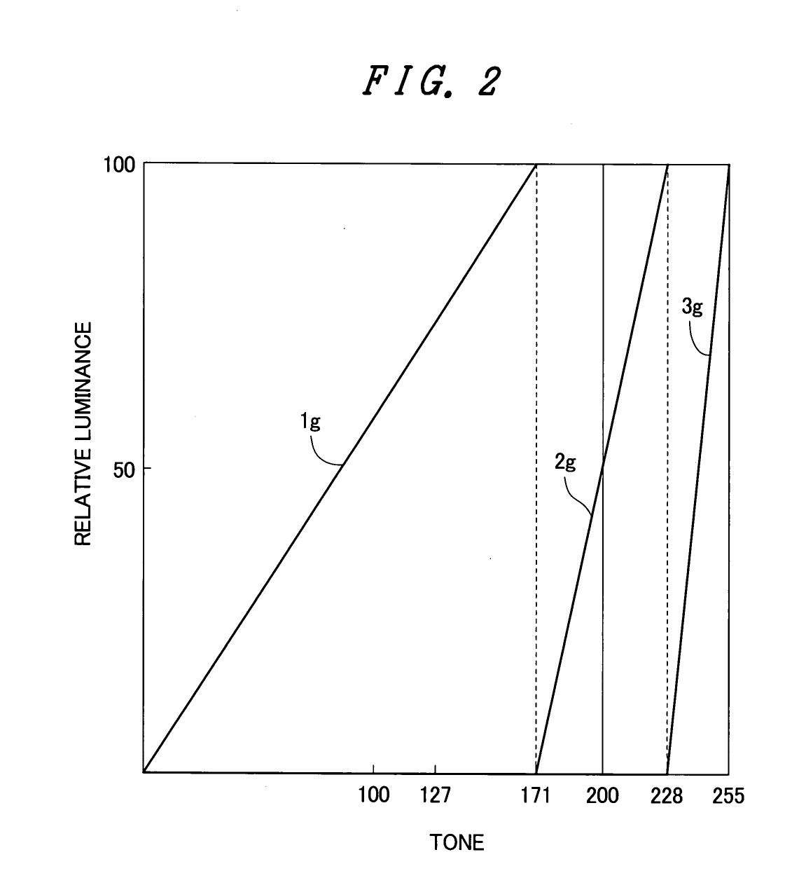

In FIG. 1, for example, the first field is a brightest field, the second field is an intermediate brightness field, and the third field is the darkest field. FIG. 2 shows an example of a range of gradations which are allocated to the respective fields. In FIG. 2, the gradations are taken on an axis of abscissas and the relative brightness is taken on an axis of ordinates, wherein the maximum gradation is a 255th gradation which corresponds to 256 bits. When the gradation is relatively low, that is, when the gradation takes a value equal to or below a 171th gradation, only the field which is allocated to 1g contributes to the formation of images. When the gradation takes a value which exceeds the 171th gradation and equal to or below a 228th gradation, the field allocated to 1g and the field allocated to 2g contribute to the formation of images. When the gradation takes a value which exceeds the 228th gradation, all of the fields allocated to 1g, 2g, 3g contribute to the formation of images. Then, when the gradation assumes the maximum gradation which is a 256th gradation, all fields ranging from the first field to the third field assume the maximum brightness and hence, a white peak is displayed. For the sake of brevity, the relationship between the gradations and the brightness is set linearly in FIG. 2. However, this relationship can be changed depending on properties or the like of an actual liquid crystal display panel.

When the relationship between the gradations and the brightness shown in FIG. 2 is set, the conversion tables corresponding to the respective fields are written in the ROM shown in FIG. 1 based on the relationship, and the first field conversion table, the second field conversion table and the third field conversion table read the conversion tables each time the display device is turned on. Although the respective conversion tables include the number of data equal to the number of frame data of the input data, the respective conversion tables differ from each other in the relationship between the gradations and the brightness. Then, the field display data ranging from the first field to the third field is read by the display data selection circuit and is outputted to the data driver. A reading speed of the respective fields is three times as fast as the reading speed of the input data.

The relationships between the gradations and brightness (hereinafter, also referred to as gradation-brightness characteristics) 1g, 2g, 3g shown in FIG. 2 are candidates for tables allocated to respective fields. For example, when necessary, the relationship 1g may be allocated to the third field, the relationship 3g may be allocated to the first field, and the relationship 2g may be allocated to the second field. As will be explained later, this manner of allocation brings about effects for preventing moving image blurring which differ from each other.

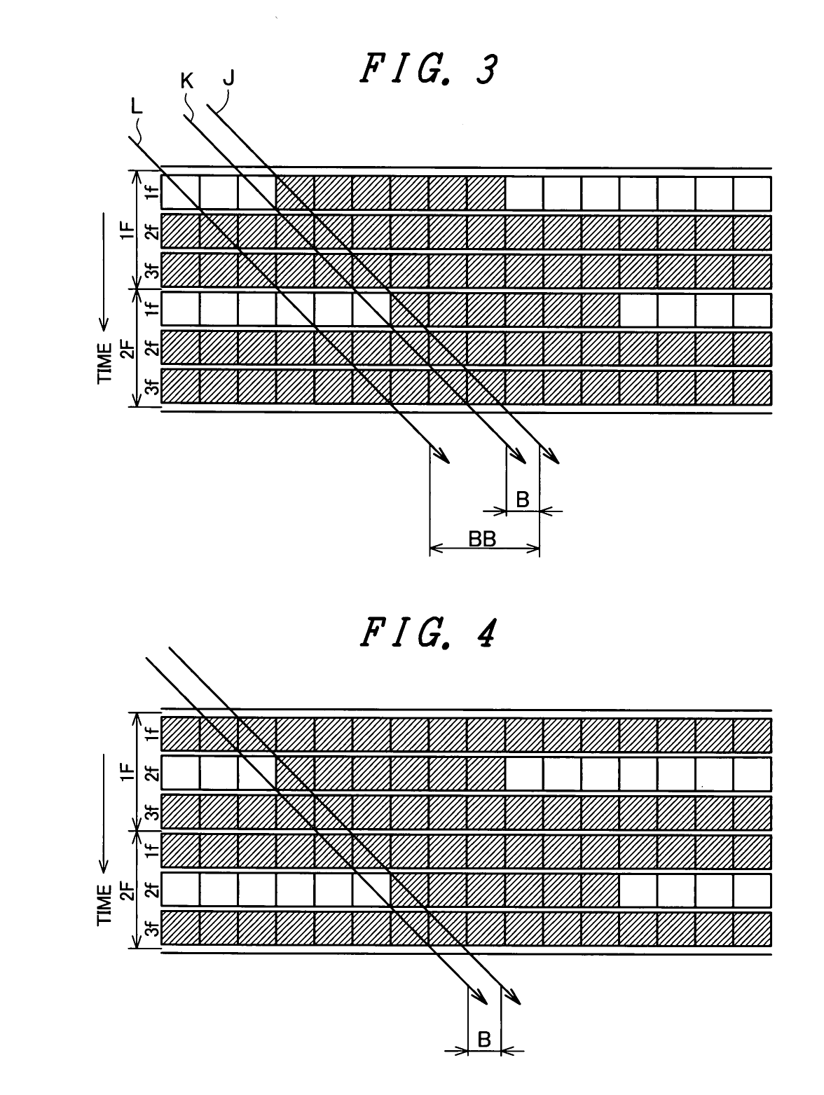

In FIG. 2, when the gradation is the 100th gradation, for example, the brightness data is outputted only to the field which corresponds to 1g and data on other field is zero. Accordingly, in such a case, black is written within ⅔ of 1 frame period and hence, the moving image blurring can be remarkably reduced. One example of this case is shown in FIG. 3. FIG. 3 shows the case in which the gradation-brightness characteristic 1g shown in FIG. 2 is allocated to the first field. In FIG. 3, a lapse of time is taken on an axis of ordinates, wherein symbol 1F indicates 1 frame period, symbol if indicates a first field, symbol 2f indicates a second field, and symbol 3f indicates a third field. That is, FIG. 3 shows that 1 frame is constituted of 3 fields. The movement of an image within the corresponding time is taken on an axis of abscissas. In FIG. 3, 3 pixels are assumed to move within 1 frame period. Although a moving quantity of the pixel is set small for the sake of brevity, the same idea is fundamentally applicable even when the moving quantity of the pixel is increased.

In FIG. 3, an arrow J shows the movement of an image which human eyes predict when the image is moved. However, in this embodiment, the brightness of the pixel is fixed during 1 field and hence, an image indicated by an arrow K is also recognized by the human eyes and hence, the difference B between the arrow J and the arrow K is recognized as moving image blurring by the human eyes. Here, a quantity of moving image blurring which the human eyes recognize when the black insertion is not performed is expressed as the difference BB between the arrow J and an arrow L shown in FIG. 3. It is understood from FIG. 3 that the quantity of moving image blurring is largely reduced compared to the quantity of moving image blurring of the conventional example.

FIG. 4 shows a case in which the gradation-brightness characteristic 1g shown in FIG. 2 is made to correspond to the second field. Also in this case, a quantity of moving image blurring is substantially equal to the quantity of the moving image blurring in the case in which the gradation-brightness characteristic 1g is made to correspond to the first field shown in FIG. 2. Although not shown in the drawing, a quantity of moving image blurring is substantially equal to the quantity of the moving image blurring in the case in which the gradation-brightness characteristic 1g is made to correspond to the third field shown in FIG. 2.

Next, when the gradation shown in FIG. 2 is the 200th gradation, it is necessary to use 2 fields which possess the gradation-brightness characteristic 1g and the gradation-brightness characteristic 2g. In this case, unless the gradations and the brightness characteristics allocated to the respective fields are properly selected, it is impossible to obtain a sufficient moving image blurring effect even when the frame is expressed by 3 fields.

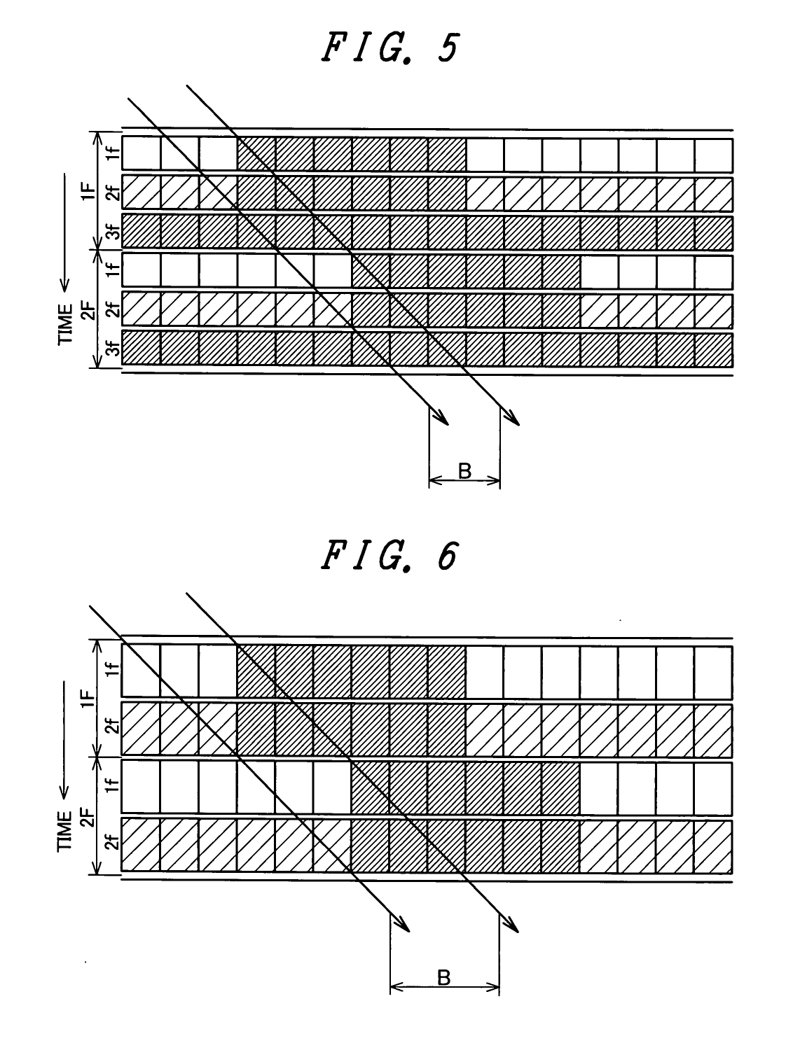

FIG. 5 shows a case in which the gradation-brightness characteristic 1g shown in FIG. 2 is made to correspond to the first field, the gradation-brightness characteristic 2g shown in FIG. 2 is made to correspond to the second field, and the gradation-brightness 3g shown in FIG. 2 is made to correspond to the third field. This case is referred to as a first mode. In this case, a value of B in FIG. 5 indicates a quantity of moving image blurring. FIG. 6 shows a case in which 1 frame is expressed by 2 fields for a comparison purpose. This case also corresponds to the case of the 200th gradation in FIG. 2. In FIG. 2, to generate the brightness of 200th gradation, it is necessary to use the gradation-brightness characteristic 1g and the gradation-brightness characteristic 2g and hence, complete black is not displayed in either one of two fields. Symbol B in FIG. 6 indicates a quantity of moving image blurring. As can be understood from a comparison of FIG. 5 and FIG. 6, the moving image blurring can be reduced more effectively in the case shown in FIG. 5 than the case shown in FIG. 6.

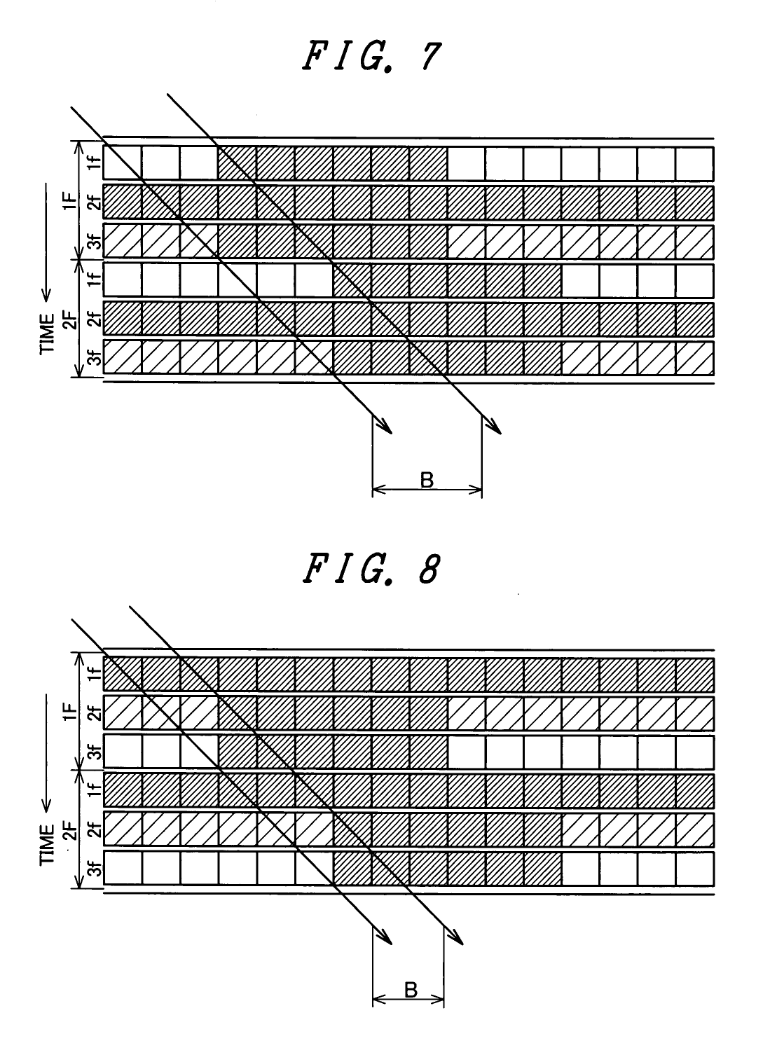

FIG. 7 shows a case in which the gradation-brightness characteristic 1g shown in FIG. 2 is made to correspond to the first field, the gradation-brightness characteristic 2g shown in FIG. 2 is made to correspond to the third field, and the gradation-brightness 3g shown in FIG. 2 is made to correspond to the second field. This case is referred to as a second mode. In this case, moving image blurring is expressed as a value B shown in FIG. 7. Compared to a case shown in FIG. 5, a quantity of moving image blurring is increased. Further, to compare the case shown in FIG. 7 and the case shown in FIG. 6, in spite of the fact that 1 frame is expressed by 3 fields by increasing frequency for writing data into the liquid crystal display panel in FIG. 7, the quantity of moving image blurring becomes substantially equal to the quantity of moving image blurring in the case in which 1 frame is expressed by 2 fields.

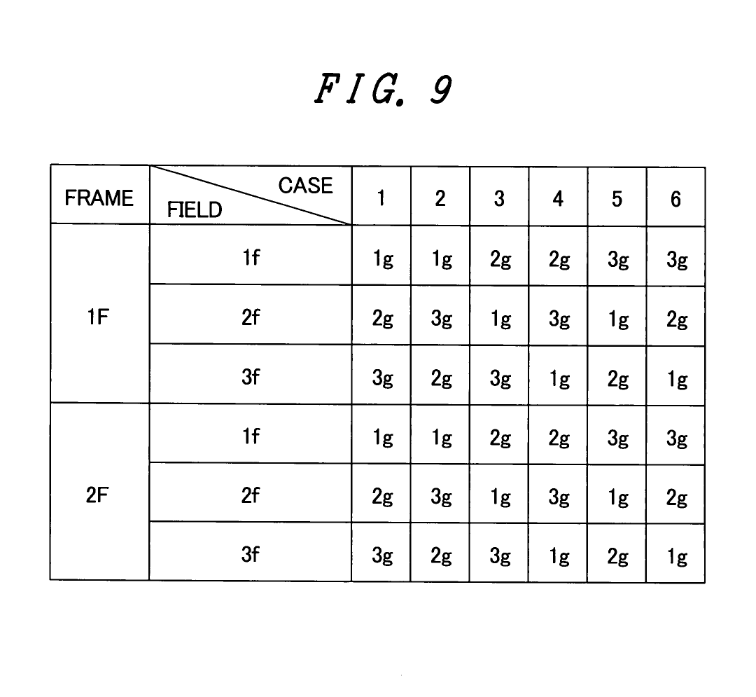

FIG. 8 shows a case in which the gradation-brightness characteristic 1g shown in FIG. 2 is made to correspond to the third field, the gradation-brightness characteristic 2g shown in FIG. 2 is made to correspond to the second field, and the gradation-brightness characteristic 3g shown in FIG. 2 is made to correspond to the first field. This case is referred to as a third mode. A quantity of moving image blurring in this case is expressed by symbol B shown in FIG. 8. In FIG. 8, the moving image blurring is reduced and a quantity of B is substantially equal to the quantity of B in the first mode.

To summarize advantageous effects against the moving image blurring in the above-mentioned modes, the blurring reduction effect becomes least when there is no black display immediately before the frame is changed or immediately after the frame is changed. That is, it is necessary to obviate these combinations. While it is possible to obtain a large moving image blurring reduction effect when the field of black display exists immediately before the frame is changed or immediately after the frame is changed, such an effect can be further increased by eliminating the brightest field immediately before the black field.

The number of methods for expressing 1 frame by 3 fields is 3!, that is, 6. All cases in allocating the respective gradation-brightness characteristics to respective fields are expressed in a Table shown in FIG. 9. FIG. 9 shows 6 cases for 2 frames. 1 frame is formed of 3 fields, wherein 1g, 2g, 3g respectively correspond to the gradation-brightness characteristics shown in FIG. 2. To classify the respective data based on the above-mentioned finding, the case 1 shown in FIG. 9 corresponds to the above-mentioned first mode and exhibits the largest moving image blurring reduction effect. The case 6 shown in FIG. 9 corresponds to the above-mentioned third mode and exhibits the moving image blurring reduction effect substantially equal to the moving image blurring reduction effect of the above-mentioned first mode. The cases which exhibit the least moving image blurring reduction effect are the case 2 and the case 4 which correspond to the above-mentioned second mode. These cases should be obviated from a viewpoint of the moving image blurring reduction. Although the case 3 and the case 5 do not belong to any modes, these cases exhibit the moving image blurring reduction effect substantially equal to the moving image blurring reduction effect of the above-mentioned first mode or third mode only under the condition that 3g is black. Here, the correspondence between the respective fields and the respective gradation-brightness characteristics may be written in the ROM 113 shown in FIG. 1.

As described above, while this embodiment reduces the moving image blurring by expressing 1 frame using 3 fields, this embodiment describes that the moving image blurring reduction effect largely differs depending on setting of the gradation-brightness characteristics of respective fields. Further, by setting the field exhibiting the lowest brightness (gradation-brightness characteristic 3g shown in FIG. 2) immediately before or immediately after the frame is changed, and by obviating the setting of the field exhibiting the maximum brightness (gradation-brightness characteristic 1g shown in FIG. 2) immediately before the field exhibiting the lowest brightness, it is possible to obtain a large moving image blurring reduction effect.

### Embodiment 2

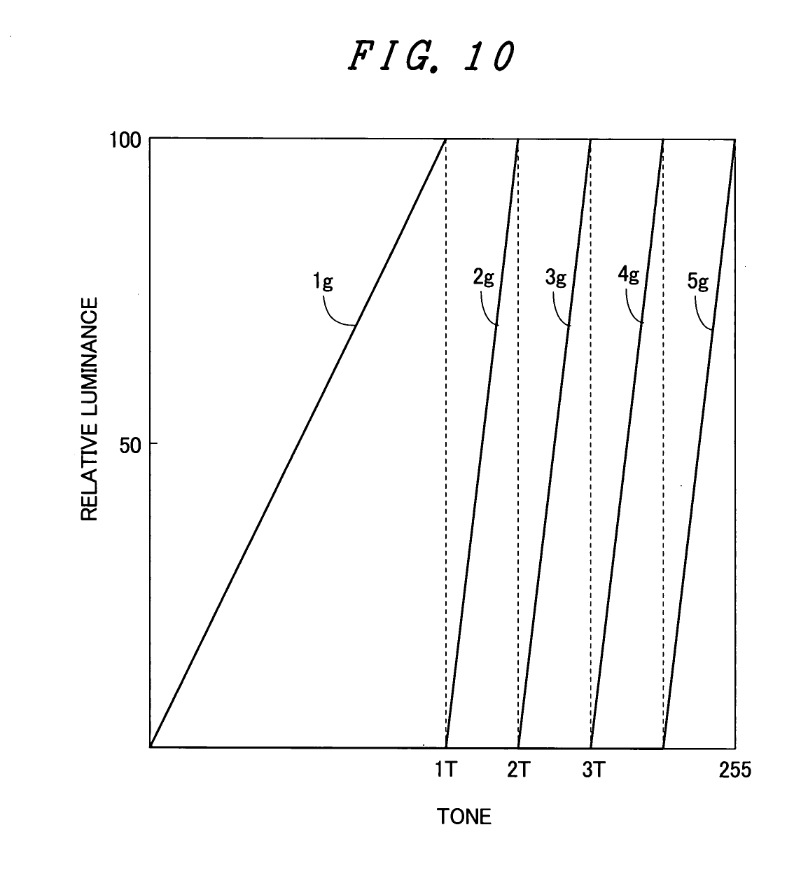

Although the embodiment 1 reduces the moving image blurring by expressing the image corresponding to 1 frame using 3 fields, in this embodiment, 1 frame is expressed by n pieces of fields for finely reducing the moving image blurring. FIG. 10 shows such an example in which 1 frame is expressed by 5 fields.

In FIG. 10, up to a gradation 1T, only the field corresponding to the gradation-brightness characteristic 1g expresses an image and other fields perform a black display. Up to a gradation 2T, the field corresponding to the gradation-brightness characteristic 1g and the field corresponding to the gradation-brightness characteristic 2g express an image, and other fields perform a black display. In this manner, by dividing 1 frame into the larger number of fields, chances of inserting black in various screens are increased and hence, the image blurring can be reduced correspondingly.

The system for this case is configured such that, in FIG. 1, the capacitance of the frame memory 110, the capacitance of ROM 113, and the number of conversion tables 114, 115, 116 and the like corresponding to the gradation-brightness characteristics are increased corresponding to the number of fields. Further, a speed for writing field display data into the data driver 124 becomes 5 times as fast as a corresponding speed of the input data 101.

When 1 frame is expressed by n fields, the number of combinations of the correspondence between the fields and the gradation-brightness characteristics becomes n!. Also in this case, depending on the correspondence between the field and the gradation-brightness characteristic, the moving image blurring reduction effect largely differs. When 1 frame is expressed by 5 fields as shown in FIG. 10, the number of combinations becomes 5!, that is, 120.

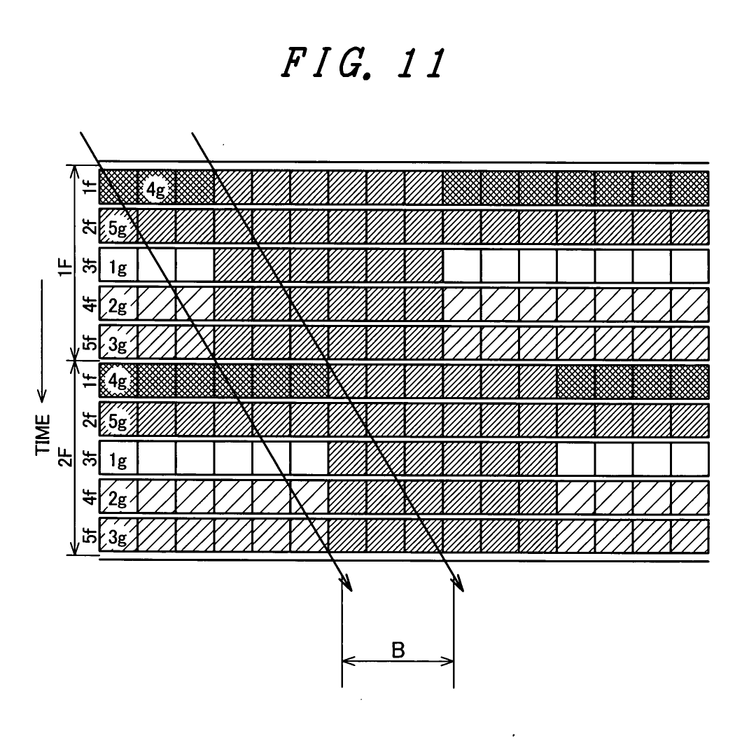

The combination which is considered first is a method which arranges the brightest gradation-brightness characteristic 1g in FIG. 10 at the center of the frame. In FIG. 11, the gradation-brightness characteristic 1g is allocated to the third field, the gradation-brightness characteristic 2g is allocated to the fourth field, the gradation-brightness characteristic 3g is allocated to the fifth field, the gradation-brightness characteristic 4g is allocated to the first field, and the gradation-brightness characteristic 5g is allocated to the second field. In this case, when the brightness is low, that is, when the gradation-brightness characteristics 1g, 2g or the like is used, there arises no problem. However, when the brightness is increased and the gradation-brightness characteristic up to 4g is used, it is difficult to acquire a sufficient moving image blurring reduction effect. In this case, the moving image blurring is expressed by symbol B in FIG. 11.

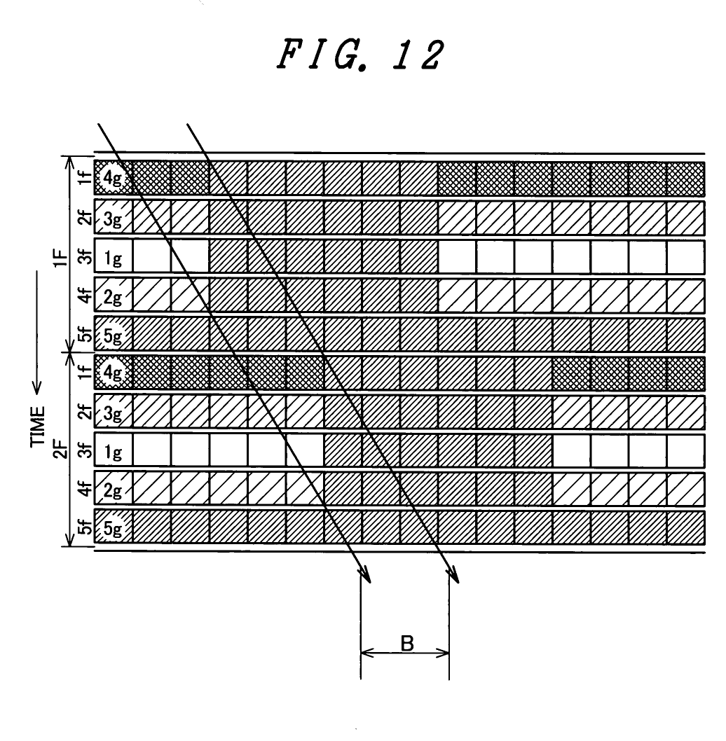

To the contrary, in FIG. 12, although the gradation-brightness characteristic 1g shown in FIG. 10 is allocated to the third field and the gradation-brightness characteristic 2g shown in FIG. 10 is allocated to the fourth field in the same manner as the case shown in FIG. 11, the gradation-brightness characteristic 5g is allocated to the fifth field and the gradation-brightness characteristic 4g is allocated to the first field. In this case, even when the gradation-brightness characteristic is used up to the gradation-brightness characteristic 4g, it is possible to acquire the moving image blurring reduction effect. The case shown in FIG. 12 is characterized by setting the minimum gradation-brightness characteristic 5g (black in this case) at the final field of 1 frame.

The similar advantageous effects can be also obtained by allocating the minimum gradation-brightness characteristic 5g to the initial field of 1 frame. Further, in FIG. 12, the next minimum gradation-brightness characteristic 4g is arranged in the initial field of the frame. By setting the gradation-brightness characteristics in this manner, it is possible to further increase a black insertion effect with respect to an image which uses the gradation-brightness characteristic 3g. Further, as can be understood from FIG. 12, by continuously arranging the fields which are allocated to the high gradation-brightness characteristics 1g, 2g, it is possible to cope with the moving image blurring more effectively.

It is needless to say that, besides the above-mentioned orders of gradation-brightness characteristics, it is possible to adopt the ascending order of 1g, 2g, . . . 5g or the descending order of 5g, 4g, . . . 1g. Also in these cases, the gradation-brightness characteristic 5g which has the highest probability of performing a black display is set in the initial or final field and hence, it is possible to acquire the substantially equal image blurring reduction effect.

### Embodiment 3

The embodiment 1 and the embodiment 2 cope with the moving image blurring by forming 1 frame using 3 or more fields which differ from each other in the gradation-brightness characteristic. In these embodiments, as the brightness approximates the maximum brightness, an image display is performed in all fields and hence, the black display is not performed whereby the moving image blurring cannot be eliminated. In this embodiment, in forming 1 frame using 3 or more fields, no signal is written in 1 field and the field always performs a black display. A crucial point in this embodiment lies in that the field in which the black display is always performed is set to either an initial field or a last field of the frame.

In forming 1 frame using 3 fields, the combination of the fields and the gradation-brightness characteristics when the black display is always performed in 1 field does not essentially differ from the corresponding combination in the embodiment 1. That is, by using the field which always performs the black display in place of the gradation-brightness characteristic 3g in the embodiment 1, it is possible to acquire a moving image blurring reduction effect.

In forming 1 frame using 3 fields, when the black display is always performed in 1 field, an image is formed using 2 fields. Accordingly, compared to a case in which 1 frame is formed of only 1 field, a value of the peak brightness becomes ⅔. However, compared to a conventional case adopting the black insertion which forms 1 frame using 2 fields and exhibits the peak brightness value of ½, the lowering of the peak brightness is not large.

In forming 1 frame using n fields, the combination of the fields and the gradation-brightness characteristics when the black display is always performed in 1 field does not substantially differ from the corresponding combination in the embodiment 2. That is, with the use of the field in which the black is always displayed in place of the lowest gradation-brightness characteristic in the embodiment 2, it is possible to acquire the moving image blurring reduction effect.

In forming 1 frame using n fields, when the black display is always performed in 1 field, an image is formed using (n−1) fields. Accordingly, compared to a case in which 1 frame is formed of only 1 field, a value of the peak brightness becomes (n−1)/n. However, compared to a conventional case adopting the black insertion which forms 1 frame using 2 fields and exhibits the peak brightness value of ½, the lowering of the peak brightness becomes extremely small.

### Embodiment 4

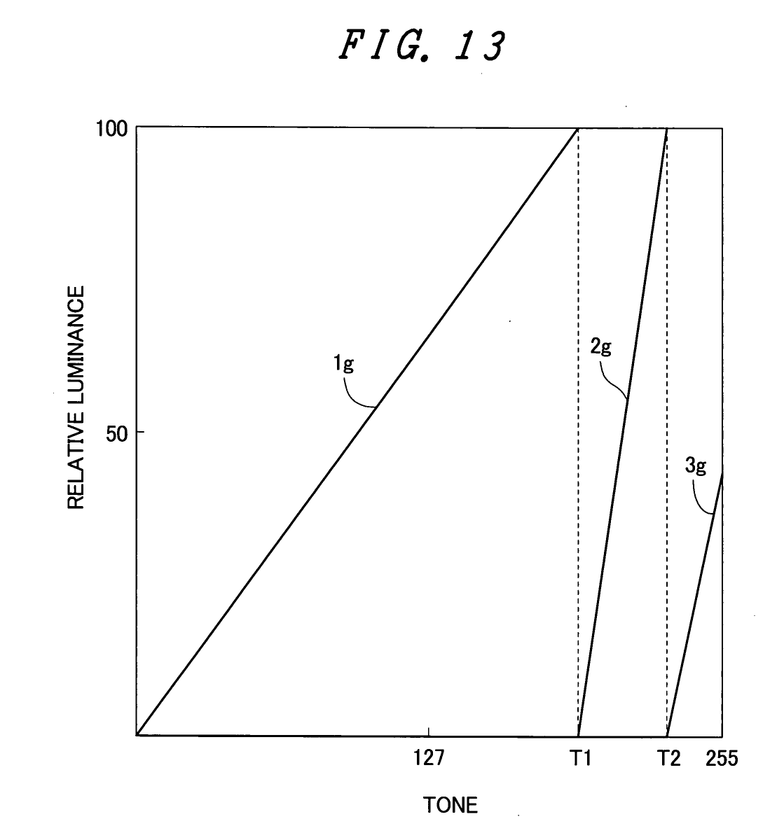

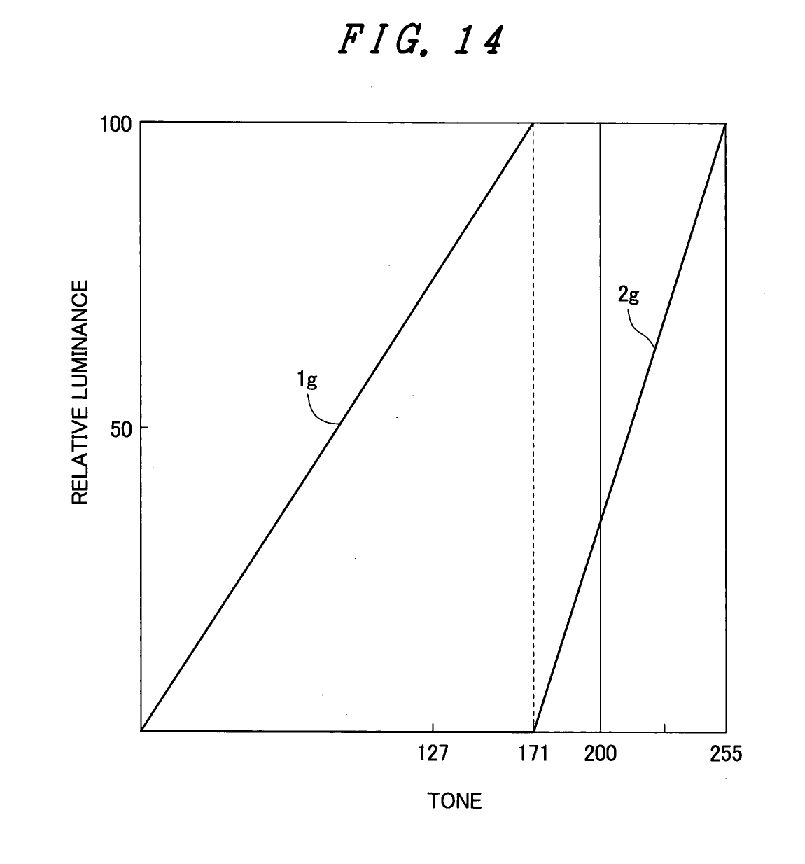

FIG. 13 shows a fourth embodiment. The embodiment 1 and the embodiment 2 display the maximum brightness in all fields at the maximum gradation and hence, there is no reduction of the moving image blurring due to black insertion. FIG. 13 shows a case in which 1 frame is formed of 3 fields. When the gradation becomes T2 or more, a region exhibiting the gradation-brightness characteristic 3g is used. In this embodiment, even at the maximum gradation, the gradation-brightness characteristic 3g is set smaller than the maximum brightness. Due to such setting, it is possible to acquire at least two following advantageous effects.

One advantageous effect is that the gradation T2 which moves from the gradation-brightness characteristic 2g to the gradation-brightness characteristic 3g can be increased. In the gradation-brightness characteristic 3g, to express the brightness change from the minimum brightness to the maximum brightness, it is necessary to ensure the gradations within a fixed range. However, in this embodiment, it is unnecessary to output the maximum brightness in the gradation-brightness characteristic 3g and hence, the gradation range of the gradation-brightness characteristic 3g can be reduced whereby the value of T2 in FIG. 13 can be increased correspondingly. Accordingly, chances that the region of the gradation-brightness characteristic 3g is used can be reduced thus enhancing the moving image blurring reduction effect attributed to black insertion. Another advantageous effect is that the maximum brightness at the gradation-brightness characteristic 3g can be lowered and hence, even when the region of the gradation-brightness characteristic 3g is used, it is possible to reduce an image retention effect on naked eyes corresponding to the lowering of the brightness.

In FIG. 13, although the maximum brightness in 1 frame is also lowered corresponding to the lowering of the maximum brightness in the gradation-brightness characteristic 3g, the lowered amount only contributes to the lowering of the maximum brightness for the 3g region and hence, the lowered amount is small.

Although FIG. 13 shows a case in which 1 frame is formed of 3 fields, the same advantageous effects can be acquired by forming 1 frame using n pieces of fields. Also in this case, the maximum brightness of the field which is allocated to the region of the highest gradation is set lower than the brightnesses of other fields. Also in this case, the moving image blurring can be reduced due to the substantially same reasons as the above-mentioned case in which 1 frame is formed using 3 fields. The advantageous effects acquired when this embodiment is applied to n pieces of fields are limited by an amount that the number of fields is increased. On the other hand, the case which forms 1 frame using n pieces of fields can further reduce the lowering of brightness than the case which forms 1 frame using 3 fields. The number of fields may be selected or determined based on properties of an image to be displayed.

Although the explanation has been made using the liquid crystal display device which adopts TFTs as the display device in the above-mentioned embodiments, the present invention is also applicable to an organic EL display device which adopts TFTs in the substantially same manner.

What is claimed is:

1. A display device of a hold response type which holds a display of gradations for a fixed period, wherein
1 frame is divided into 3 fields,
a first field displays an intermediate gradation between a 0th gradation and a gradation T1,
a second field displays an intermediate gradation between the gradation T1 and a gradation T2,
a third field displays an intermediate gradation between the gradation T2 and a maximum gradation,
the gradation T1 and the gradation T2 are set to a relationship of gradation T1<gradation T2, and
the third field is set at either one of an initial stage and a final stage of a frame.

2. A display device according to claim 1, wherein when the third field is set at the initial stage of the frame, the second field and the first field are sequentially set.

3. A display device according to claim 1, wherein when the first field is set at the initial stage of the frame, the second field and the third field are sequentially set.

4. A display device according to claim 1, wherein periods of the first field, the second field and the third field are set substantially equal to each other.

5. A display device according to claim 1, wherein the brightnesses of the first field, the second field and the third field at the maximum gradation are set substantially equal to each other.

6. A display device according to claim 1, wherein the brightness of the third field is smaller than the brightnesses of the first field and the second field at the maximum gradation.

7. A display device of a hold response type which holds a display of gradations for a fixed period, wherein
1 frame is divided into 3 fields,
a first field displays an intermediate gradation between a 0th gradation and a gradation T1,
a second field displays an intermediate gradation between the gradation T1 and a maximum gradation,
the third field always displays a black level, and
the third field is set at either one of an initial stage and a final stage of a frame.

8. A display device according to claim 7, wherein when the third field is set at the initial stage of the frame, the second field and the first field are sequentially set.

9. A display device according to claim 7, wherein when the first field is set at the initial stage of the frame, the second field and the third field are sequentially set.

10. A display device according to claim 7, wherein periods of the first field, the second field and the third field are set substantially equal to each other.

11. A display device of a hold response type which holds a display of gradations for a fixed period, wherein
1 frame is divided into 4 or more fields,
4 or more fields include a first field which displays an intermediate gradation between a 0th gradation and a gradation T1, the second field which displays an intermediate gradation between the gradation T1 and a gradation T2, the fourth field which displays an intermediate gradation between the gradation T4 and a maximum gradation, and the third field which displays an intermediate gradation between the gradation T3 and the gradation T4,
the gradation T1, the gradation T2, the gradation T3 and the gradation T4 are set to a relationship of gradation T1<gradation T2<gradation T3<gradation T4, and
the fourth field is set at either one of an initial stage and a final stage of a frame.

12. A display device according to claim 11, wherein the first field and the second field are continuously set.

13. A display device of a hold response type which holds a display of gradations for a fixed period, wherein
1 frame is divided into 4 or more fields,
4 or more fields include a first field which displays an intermediate gradation between a 0th gradation and a gradation T1, a second field which displays an intermediate gradation between the gradation T1 and a gradation T2, a third field which displays an intermediate gradation between the gradation T3 and a maximum gradation, and a fourth field which always displays a black level,
the gradation T1, the gradation T2 and the gradation T3 are set to a relationship of gradation T1<gradation T2<gradation T3, and
the fourth field is set at either one of an initial stage and a final stage of a frame.

14. A display device according to claim 13, wherein the first field and the second field are continuously set.

15. A display device according to claim 1, wherein the display device is a liquid crystal display device.

16. A display device according to claim 1, wherein the display device is an organic EL display device.

17. A display device according to claim 7, wherein the display device is a liquid crystal display device.

18. A display device according to claim 7, wherein the display device is an organic EL display device.

19. A display device according to claim 13, wherein the display device is a liquid crystal display device.

20. A display device according to claim 13, wherein the display device is an organic EL display device.
